(19) United States
(12) Patent Application Publication
(10) Pub. No.: US 2003/0067654 A1
(43) Pub. Date: Apr. 10, 2003

(54) Electro-optical inclination detector and device comprising such a detector for generating an alarm as a function of the inclination of the body, or of a part of the body, of an individual

(76) Inventors: Gerard Dumoutier, Sallanches (FR); Alain Zozime, Fontainebleau (FR)

Correspondence Address: HENDERSON & STURM LLP, 1213 MIDLAND BUILDING, 206 SIXTH AVENUE, DES MOINES, IA, 50309-4076, US

(21) Appl. No.: 10/278,563

(22) Filed: Oct. 23, 2002

Related U.S. Application Data
(63) Continuation of application No. PCT/IB01/00682, filed on Apr. 25, 2001.

(30) Foreign Application Priority Data
Apr. 25, 2000 (FR) 00.05369

(51) Int. Cl. H04B 10/00

(52) U.S. Cl. 359/142

(57) ABSTRACT

The invention concerns an inclination detector comprising a displacement guide, a member mobile along the displacement guide, and means cooperating with the mobile member to control an alarm generator based on the inclination of the displacement guide. The invention is characterised in that said means comprise electrooptical transmitter and receiver for respectively transmitting and receiving an optical beam so as to activate or deactivate the alarm generator when the mobile member obstructs the optical beam by moving along the displacement guide. Preferably, the mobile member as well as the electrooptical transmitter and receiver are arranged in a sealed displacement guide. The inventive detector is fixed to an undergarment enabling a user to acquire and integrate a movement adapted to the spine.

### CROSS REFERENCE TO RELATED APPLICATIONS

This application is a Continuation application of PCT/IB01/00682 filed Apr. 25, 2001, which claimed priority of French Application No. 00.05369 filed Apr. 25, 2000, entitled “Electro-optical Inclination Detector and Device Comprising Such a Detector for Generating an Alarm as a Function of the Inclination of the Body, or of a Part of the Body, of an Individual” all of which are included in their entirety by reference made hereto.

### BACKGROUND OF THE INVENTION

1. Field of the Invention

The invention relates to an inclination detector, that is to say a detector capable of leading to the determination of an inclination with respect to a reference direction, for example the vertical direction dictated by the force of gravity. The invention also relates to a device comprising such a detector for generating an alarm as a function of the inclination of the body, or of a part of the body, of an individual.

2. Description of the Related Art

The document WO 81/01506 discloses an inclination detector comprising a pendulum suspended by one end from a housing. Goniometric means interact with the pendulum so as to control an alarm generator as a function of the inclination of the housing with respect to the local vertical. The housing is fixed on an anatomical vest intended to be worn by an individual, for example on the back. When the individual leans forward, the goniometric means record of the movement of the pendulum as far as a threshold which is fixed in advance, the crossing of which activates the alarm generator. The individual is then warned that he or she is in the process of making a movement which is advised against for his or her back.

By putting on the anatomical vest, the user by himself or herself succeeds in arranging the inclination detector substantially in the same dorsal position from one use to the next. The alarm generator is also fixed to the vest, so as to allow the user to move around with the inclination detector. The device described in this document hence permits both autonomous and ambulatory use.

Despite this dual nature of being autonomous and ambulatory, this known arrangement is nevertheless not entirely satisfactory. In mechanical terms, the oscillations of the pendulum are capable of activating the alarm generator without the user having actually performed a movement, advised against for the spinal column, leading to the inclination threshold being crossed. This drawback is even more noticeable when the individual moves around with the inclination detector. Furthermore, the pendulum and the goniometric means entail significant bulk, so that the housing worn by the individual is not ergonomic and is visible on the back.

The document WO 83/03747 describes another type of inclination detector, comprising a member which can move along a displacement guide. A projecting tab makes it possible to place the detector on the body of an individual, for example on the back. The detector is held in place by adhesively bonding the projecting tab onto the skin, or by a retaining bandage.

### BRIEF SUMMARY OF THE INVENTION

According to a first embodiment, a sleeve is mounted so as to slide around a cylindrical tube. A first flexible element and a second flexible element are mounted at each of the ends of the tube, and they are connected to an electronics unit which is joined to an alarm generator. The sleeve is provided with a magnet, which makes it possible to bring the two flexible elements into contact during its movement as a function of the inclination of the tube. The alarm generator is then activated via the electronics unit, and the user is warned that he or she is in the process of exceeding an inclination which is advised against for his or her back.

According to a second embodiment, a metal ball moves by rolling inside a cylindrical tube. The tube is provided with two internal electrical terminals, which are arranged at one end and are connected to the electronics unit which is joined to the alarm generator. When the tube reaches a particular inclination, the ball moves towards the electrical terminals and, at their contacts, makes an electrical connection which activates the alarm generator via the electronics unit. Here again, the user is warned that he or she is in the process of exceeding an inclination which is advised against for his or her back.

In both these embodiments, the electronics unit and the alarm generator are intended to be worn by the user, in order to allow him or her to move around with the inclination detector. From one use to the next, however, the fitting of the detector on the same region of the user's anatomy needs to be carried out by a specialist. In other words, the device described by these two embodiments is ambulatory but not autonomous.

In the first embodiment, the electrical contact-making which activates the alarm generator is liable to be perturbed or even interrupted by mechanical vibrations of the flexible elements, which are generated in particular when the user moves around. Arranging the sleeve outside the cylindrical tube moreover causes the detector to be quite bulky.

In the second embodiment, the mobile member is used as a conductor between the two electrical terminals of the displacement tube. This arrangement makes it necessary to select these three elements in the same metallic material, in order to avoid electrochemical corrosion of the surfaces that are in contact, which reduces the electrical conductivity. The onset of this corrosion is promoted, in particular, by humidity in the ambient air. This arrangement also requires a minimum pressure of the ball on the terminals in order to break the oxide layer which is inevitably formed on the surface of these metallic elements. Increasing the mass of the ball in order to increase the contact pressure is incompatible with reducing the bulk and weight of the detector.

One of the objects of the invention is to improve the design of known inclination detectors, and in particular to increase their reliability when they are used in a device for generating an alarm as a function of the inclination of the body, or of a part of the body, of an individual. The invention also relates to an inclination detector which facilitates the use of the device.

To that end, the invention relates to an inclination detector, comprising a displacement guide, a member which can move along the displacement guide, and means which interact with the mobile member so as to control an alarm generator as a function of the inclination of the displacement guide, characterised in that the means comprise an electro-optical transmitter and an electro-optical receiver, for respectively transmitting and receiving an optical beam so as to activate or deactivate the alarm generator when the mobile member blocks the optical beam by moving along the displacement guide.

According to the invention, the blocking of the optical beam makes it possible to control the alarm generator without requiring physical contact between the electro-optical transmitter and the electro-optical receiver. Fixing these stably with respect to the displacement guide limits the risk that vibrations of the detector may perturb the blocking of the optical beam. Furthermore, since the mobile member does not have any electrical-contact function, the aforementioned problems of contact pressure and electrochemical corrosion are overcome.

In order to reduce the bulk of the detector, the mobile member is preferably in the form of a flat weight, which moves by sliding inside a housing which is also flat. A further option is to design the mobile member in the form of a ball or a cylinder of small diameter running in a groove of the housing. Advantageously, the weight or the ball is made from a plastic material, which contributes to reducing the weight of the detector.

Preferably, the flat weight is provided with a projecting tab which forms a shutter member for the optical beam. The electro-optical transmitter and the electro-optical receiver are separated from one another so as to permit insertion of the projecting tab, while avoiding insertion of the weight itself between the transmitter and the receiver. By positioning the transmitter and the receiver close to one another, the consumption of the detector is reduced since the optical transmission efficiency between the two electro-optical elements is higher.

The detector according to the invention is integrated into a device designed for generating an alarm as a function of the inclination of the body, or of a part of the body, of an individual. In an autonomous and ambulatory device which is known per se, comprising an anatomical support intended to be worn by the individual, and one or more inclination detectors, which are each fixed on the anatomical support and are joined to an alarm generator, the detector according to the invention contributes to increasing the reliability of the device by limiting the risk that vibrations generated by the user's movement may perturb the blocking of the optical beam. The detector also makes it possible to overcome the contact problems due to oxidation and corrosion generated by humidity in the ambient air. Furthermore, the reduction in the size and weight of the detector gives the device a more ergonomic nature.

In order to increase the hygienic nature of such a device, the mobile member as well as the electro-optical transmitter and the electro-optical receiver of the detector are arranged in a leaktight displacement guide, making it possible to wash the anatomical support without removing the detectors. Preferably, the alarm generator is arranged in a leaktight housing fixed to the anatomical support.

Advantageously, the anatomical support is an undergarment in order to make use of the device more discreet.

According to the principle of feedback, the device according to the invention makes it possible for an individual to acquire and assimilate a repertoire of actions protecting him or her from actions which are unsuited and harmful to his or her spinal column. The alarm generator is activated by the inclination detectors which are fixed on the undergarment, in order to warn the individual that he or she is in the process of making an unsuitable action, and it is deactivated when the individual performs the appropriate action. Daily wearing of the undergarment allows the user to progressively learn about the unsuitable actions and to progressively acquire and assimilate the suitable actions.

The daily training is particularly facilitated by the autonomous, ambulatory, ergonomic and hygienic nature of the device.

Other characteristics and advantages will become apparent on reading a detailed description of the invention, illustrated by the drawings.

### BRIEF DESCRIPTION OF THE DRAWINGS

FIG. 1 is an overall view of an inclination detector joined to an alarm generator via an electronics unit for acquisition and processing.

FIG. 2 is a plan view more particularly showing an internal arrangement of the various constituent elements of the detector.

FIG. 3 shows the displacement guide of the detector in perspective.

FIGS. 4a and 4b show, respectively in profile and from behind, an individual who is in the standing position and is wearing an undergarment on which inclination detectors are fixed.

FIG. 5 is an overall view of a housing containing the alarm generator and an electronics unit for processing and acquisition.

### DETAILED DESCRIPTION OF THE INVENTION

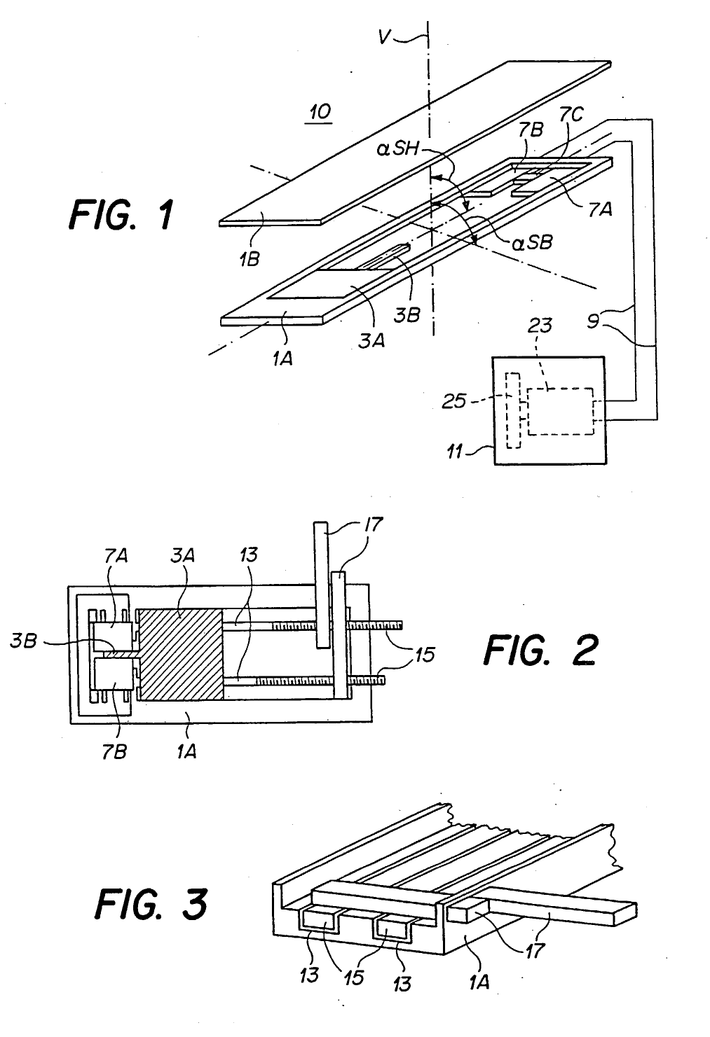

An inclination detector is denoted overall by the reference 10 in FIG. 1. The inclination detector 10 comprises a housing 1A, which is used as a displacement guide for a weight 3A that can move along the displacement guide. An electronics unit 23 for acquisition and processing is joined to the detector 10 and to an alarm generator 25.

According to the invention, the detector comprises an electro-optical transmitter 7A and an electro-optical receiver 7B for respectively transmitting and receiving an optical beam 7C. The transmitter and the receiver are arranged, with respect to the housing 1A, so that the weight 3A blocks the optical beam 7C when it moves along the housing 1A as a function of the inclination of the latter.

The electro-optical transmitter and the electro-optical receiver consist, for example, of a photodiode 7A and a phototransistor 7B. They are arranged inside the housing 1A, at one of its ends. The weight 3A also moves inside the housing, which is closed by a lid 1B. A supply unit, for example a cell or battery, is provided for the electro-optical transmitter and the electro-optical receiver.

In FIG. 1, α denotes the inclination of the detector with respect to the local vertical V, which is considered as the reference direction. When the detector reaches, downwards with respect to the vertical V, a threshold inclination denoted by αSB in FIG. 1, the weight 3A moves by sliding inside the housing 1A towards the end where the electro-optical emitter 7A and the electro-optical receiver 7B are arranged, until it blocks the optical beam 7C. When the optical beam 7C is blocked, the electro-optical receiver delivers an electrical signal, indicating crossing of the low threshold, to the electronics unit 23 for acquisition and processing, which activates the alarm generator 25. The generation of the alarm signifies that the downward inclination αSB has been exceeded by the detector.

If the detector is subsequently inclined upwards, it reaches a threshold inclination denoted by αSH in FIG. 1, at which the weight 3A moves towards the end of the housing opposite the one where the electro-optical transmitter and the electro-optical receiver are arranged. When the optical beam 7C is received, the receiver 7B delivers an electrical signal, indicating crossing of the high threshold, to the electronics unit 23 for acquisition and processing, which deactivates the alarm generator 25. The end the alarm signifies that the upwards inclination αSH has been exceeded by the detector.

It is important to note that the blocking of the optical beam may also deactivate the alarm generator, and hence end the alarm. In order to activate the alarm generator, and hence generate the alarm, it is sufficient for the weight to move, under the effect of the inclination of the detector, towards the end opposite the one where the electro-optical transmitter and the electro-optical receiver are arranged. This mode of operation promotes relatively rapid generation of the alarm compared with the time for moving the weight inside the housing.

The mode of operation described in the previous paragraph favours rapid ending of the alarm.

In the exemplary embodiment in FIG. 1, the electro-optical transmitter 7A and the electro-optical receiver 7B are separated from one another so as to permit the insertion of a tab 3B, which is mounted on the weight 3A so as to project from it, and which forms a shutter member for the optical beam 7C. The weight 3A and the housing 1A are both flat, in order to advantageously reduce the thickness of the detector. Preferably, the weight is made from a plastic material in order to decrease the weight of the detector. A further option is to make the housing from plastic material as well.

According to a particular embodiment of the invention (see FIGS. 2 and 3), the detector comprises channels 13 which allow a gas, for example air, to flow in the housing 1A when the weight 3A is moving inside it. These channels extend along the housing, parallel to the direction of movement of the weight. Preferably, bars 15 are inserted then immobilised inside the channels 13 in order to adjust the flow of the gas in the housing 1A.

By this arrangement, the speed of the weight is controlled by adjusting the air flow between the parts of the housing which are located in front of the weight and behind it, in its direction of movement. The adjustment is carried out by inserting then immobilising the bars 15 in the channels 13 over different insertion lengths. The adjustment of the air flow with the aid of the bars 15, which are inserted into the channels 13, also makes it possible to damp the vibrations of the weight, hence contributing to increasing the reliability of the detector.

According to another particular embodiment of the invention, which can also be seen in FIGS. 2 and 3, the detector comprises wedges 17 for adjusting the displacement travel of the weight 3A along the housing 1A. In the example of FIG. 2, the wedges 17 are inserted then immobilised in the housing 1A, at the end opposite the one where the electro-optical transmitter 7A and the electro-optical receiver 7B are arranged, and perpendicularly to the direction of movement of the weight 3A. The displacement travel of the weight is adjusted by inserting one or other of the wedges 17 into the housing 1A.

“\l 3The wedges 17 make it possible to adjust the crossing angle αSB of the low inclination threshold with respect to the reference direction, and consequently to adapt the angular range of the detector.

It should be noted that, when the mobile member is in the form of a ball, it is possible to achieve lower inclination-threshold crossing values compared with a mobile member having the form of a flat weight.

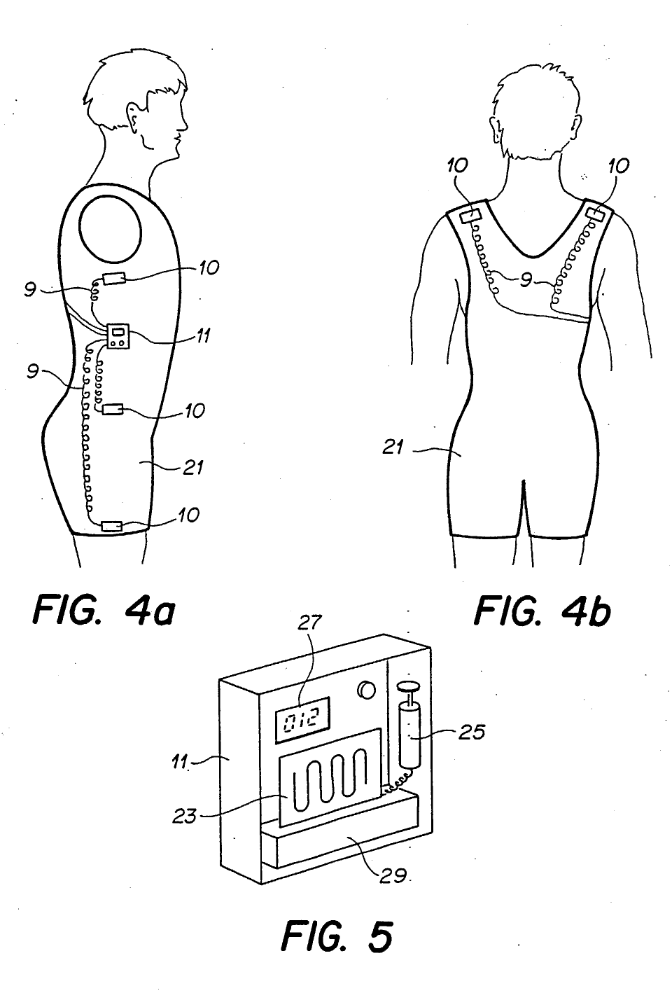

A device designed for generating an alarm as a function of the inclination of the body, or of a part of the body, of an individual comprises (see FIGS. 4a and 4b) an undergarment 21 intended to be worn by the individual, and one or more inclination detectors 10 according to the invention, which are each fixed on the undergarment and are joined to an alarm generator 25 via an electronics unit 23 for acquisition and processing.

According to the invention, the mobile member 3A as well as the electro-optical transmitter 7A and the electro-optical receiver 7B are arranged in a leaktight displacement guide 1A and 1B, in order to make it possible to wash the undergarment 21 without removing the detectors 10. The undergarment 21 is made of a technical fabric which promotes the removal of sweat, and which permits good circulation of air between the body and the external environment. The detectors 10 are, for example, stitched into a lining of the undergarment, so that they are not in direct contact with the skin.

The damping of the vibrations of the weight, which results from the adjustment of the air flow with the aid of the bars, makes it advantageously possible not to generate an alarm when the user performs a movement, for example jumping or running, which by itself does not lead to the crossing of a threshold inclination. Furthermore, the wedges make it possible to adapt the angular range of the detector to various human morphology types and to different types of movement to be monitored.

Preferably, the alarm generator 25 is arranged in a leaktight housing and is fixed to the undergarment 21, as can be seen in FIG. 4a. Likewise, the electronics unit 23 joined to the alarm generator 25, and also joined to each detector 10, is arranged in a leaktight housing fixed to the undergarment 21.

As can be seen in FIG. 5, the housing 11 contains both the electronics unit 23 for acquisition and processing and the alarm generator 25, for example a vibrator. It is, for example, made from a plastic material and arranged in an outside pocket stitched onto the undergarment.

The electronics unit 23 is connected to the electro-optical transmitter 7A and the electro-optical receiver 7B by connecting wires 9, in order to acquire signals indicating the crossing of inclination thresholds αSB or αSH delivered by the electro-optical receiver 7B of each detector 10. The electronics unit processes these crossing signals so as to activate or deactivate the alarm generator 25, and hence to generate or stop an alarm.

The housing 11 also comprises a display 27 joined to a counter (not shown) in order to display the number of alarm generations during a given period of using the undergarment. A battery or a cell 29 is accommodated in the housing 11 for independent supply of its elements. Advantageously, this energy source is used to supply the electro-optical transmitter and the electro-optical receiver of the detector or detectors fixed on the undergarment. The outside pocket of the undergarment facilitates access to the housing 11 in order to replace the cell 29.

The vibrator preferably makes it possible to generate the alarm in the form of a touch sensation for the user. A further option is to use a sound generator as the alarm generator, although the touch alarm is more discreet than the sound alarm.

In the exemplary embodiment illustrated by FIGS. 4a and 4b, the undergarment comprises four inclination detectors. An upper detector is fixed on the undergarment in order to occupy a lateral position under the armpit for the individual. This detector makes it possible to monitor the anterior flexion of the torso. A lower detector is fixed so as to occupy a position on the pelvis for the individual, at the top of the iliac crest. This detector makes it possible to monitor the retroversions of the pelvis in a seated position.

Likewise, as can be seen in FIG. 4b, a left-hand detector and a right-hand detector for the spinal column are fixed on the undergarment in order to occupy a position level with the supraspinous fossae of the scapula for the individual. These two detectors make it possible to monitor the lateral inflections of the torso. Combined use of the anterior flexion detector with one or other of the lateral inflection detectors makes it possible to monitor the rotations/flexions of the torso.

The acquisition and processing unit 23 advantageously makes it possible to filter out repetitive signals indicating crossing of the inclination thresholds αSB or αSH, which are generated when the individual performs movements such as fast walking or running, since these movements are not in themselves unsuitable. Filtering out the signals makes it possible to avoid generation of an alarm. It should be noted that this filtering is additional to the mechanical filtering of the vibrations of the weight, which is carried out by the bars 15.

One option is to fix the connecting wires 9 on the undergarment 21, for example in a lining. A further option is to connect the electronics unit 23 to the inclination detectors 10 by wireless connections. More particularly, the electro-optical transmitter 7A and the electro-optical receiver 7B of a detector, as well as the alarm generator 25 and the acquisition and processing unit 23, each have an integrated supply and means for communicating by electromagnetic waves.

1. Inclination detector, comprising a displacement guide, a member which can move along the displacement guide, and means which interact with the mobile member so as to control an alarm generator as a function of the inclination of the displacement guide, characterised in that these means comprise an electro-optical transmitter and an electro-optical receiver, for respectively transmitting and receiving an optical beam so as to activate or deactivate the alarm generator when the mobile member blocks the optical beam by moving along the displacement guide.

2. Detector according to claim 1, characterised in that the mobile member is in the form of a weight.

3. Detector according to claim 1, characterised in that the mobile member is in the form of a ball or a cylinder which moves in a groove of the housing.

4. Detector according to claim 2, characterised in that the electro-optical transmitter and the electro-optical receiver are separated from one another so as to permit the insertion of a shutter member for the optical beam, which is mounted on the weight so as to project from it.

5. Detector according to claim 1, characterised in that the mobile member or the housing is made from a plastic material.

6. Detector according to claim 1, characterised in that it comprises channels which allow a gas to flow in the displacement guide when the mobile member is moving inside it.

7. Detector according to claim 6, characterised in that it comprises bars which are inserted inside the channels in order to adjust the flow of the gas in the displacement guide.

8. Detector according to claim 1, characterised in that it comprises wedges for adjusting the displacement travel of the mobile member along the displacement guide.

9. Device designed for generating an alarm as a function of the inclination of the body, or of a part of the body, of an individual, comprising an anatomical support intended to be worn by the individual, and one or more inclination detectors according to one of the preceding claims, which are each fixed on the anatomical support and are joined to an alarm generator, characterised in that the mobile member as well as the electro-optical transmitter and the electro-optical receiver of the detectors are arranged in a leaktight displacement guide, in order to make it possible to wash the anatomical support without removing the detectors.

10. Device according to claim 9, characterised in that the alarm generator is arranged in a leaktight housing fixed to the anatomical support.

11. Device according to claim 9, characterised in that it comprises an electronics unit, joined to the alarm generator and to each detector, for acquiring and processing the signals indicating the crossing of inclination thresholds (αSB) or (αSH) delivered by the electro-optical receiver of each detector, which unit is arranged in a leaktight housing fixed to the anatomical support.

12. Device according to claim 9, characterised in that the anatomical support is an undergarment.
